(19) United States
(12) Patent Application Publication
(10) Pub. No.: US 2025/0224738 A1
(43) Pub. Date: Jul. 10, 2025

(54) INFORMATION PROCESSING APPARATUS, INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventor: AYATO IMAI, Tokyo (JP)

(21) Appl. No.: 18/981,980

(22) Filed: Dec. 16, 2024

(30) Foreign Application Priority Data
Jan. 4, 2024 (JP) 2024-000294

(51) Int. Cl. G05D 1/648; G05D 1/245; G05D 105/10

(52) U.S. Cl. CPC G05D 1/648; G05D 1/245; G05D 2105/10

(57) ABSTRACT

An information processing apparatus is configured to acquire a request for provision of labor in a specified environment, acquire sensor information measured by one or more sensors inside the environment, acquire information on a candidate group of robots that provide the labor, and select a first robot group that includes one or more robots capable of providing the labor from the candidate group based on the request and the sensor information.

### BACKGROUND OF THE INVENTION

### Field of the Invention

The present invention relates to an information processing apparatus, an information processing system, an information processing method, a storage medium, and the like.

### Description of the Related Art

In recent years, various types of robots that provide labor have been provided and developed. For example, Japanese Patent Application Laid-Open No. 2018-116659 discloses a technology of selecting and proposing a robot provided from a plurality of robots in response to a request for providing labor received from a user.

However, in the method described in Japanese Patent Application Laid-Open No. 2018-116659, the robot may not operate as expected at a site desired by a user.

### SUMMARY OF THE INVENTION

An information processing apparatus according to an embodiment of the present invention comprising: one or more memories storing instructions; and one or more processors executing the instructions to: acquire a request for provision of labor in a specified environment; acquire sensor information measured by one or more sensors inside the environment; acquire information on a candidate group of robots that provide the labor; and select a first robot group that includes one or more robots capable of providing the labor from the candidate group based on the request and the sensor information.

Further features of the present invention will become apparent from the following description of embodiments with reference to the attached drawings.

### BRIEF DESCRIPTION OF THE DRAWINGS

FIG. 1 is a diagram illustrating an example of a hardware configuration of an information processing apparatus according to the first embodiment.

FIG. 2 is a diagram illustrating an example of a usage scene of an information processing system 220 according to the first embodiment.

FIG. 3 is a functional block diagram showing a functional configuration example of an information processing apparatus according to the first embodiment.

FIG. 4 is a diagram showing an example of the contents of a robot candidate list according to the first embodiment.

FIG. 5 is a flowchart illustrating a processing example of an information processing method using the information processing apparatus according to the first embodiment.

FIG. 6 is a flowchart illustrating details of an example of the process of step S504.

FIG. 7 is a diagram illustrating a usage scene of an information processing apparatus according to the second embodiment.

FIG. 8 is a functional block diagram showing a functional configuration example of the information processing apparatus according to the second embodiment.

FIG. 9 is a flowchart illustrating an example of the processes of an information processing method according to the second embodiment.

FIG. 10 is a flowchart illustrating a detailed example of the process of step S504 according to the second embodiment.

FIG. 11 is a diagram showing an example of a UI screen for a user of the information processing apparatus according to the first embodiment or the second embodiment to transmit sensor data.

FIG. 12 is a diagram showing an example of a UI screen for a user of the information processing apparatus according to the first embodiment or the second embodiment to confirm a selected robot.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

Hereinafter, an information processing apparatus, an information processing method, and a computer program of a first embodiment according to the present invention are explained in detail by referring to drawings.

Note that, in the first embodiment, provision of labor for cleaning a floor surface will be explained as an example. Additionally, in the first embodiment, a robot suitable for providing labor is selected based on a request for providing labor from a user and sensor data of a labor execution environment that has been acquired by a terminal owned by the user.

In the first embodiment, because the state of the floor surface of the labor execution environment is analyzed based on the sensor data and the conditions for the robot operable at the site are acquired, a robot suitable for operation in the environment can be selected.

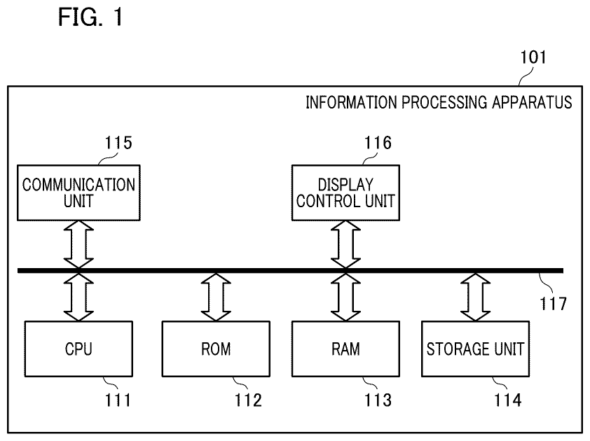

FIG. 1 is a diagram illustrating a hardware configuration example of an information processing apparatus according to the first embodiment. An information processing apparatus 101 is provided with the functions of a typical PC device and is configured by a CPU 111, a ROM 112, a RAM 113, storage units 114 such as an HDD, an SSD, and the like, a communication unit 115, a display control unit 116, and a system bus 117.

The display control unit 116 functions as a display control unit and performs control for displaying an image and various types of information on a display unit such as an LCD (not illustrated). Note that the display unit serving as a display means may be provided in the information processing apparatus or may be provided separately from the information processing apparatus.

The CPU 111 uses the RAM 113 as a work memory, executes an operating system (OS) and various computer programs stored in the ROM 112, the storage unit 114, and the like, and controls each unit via the system bus 117. The computer programs executed by the CPU 111 serving as a computer include a computer program for executing processing to be described below.

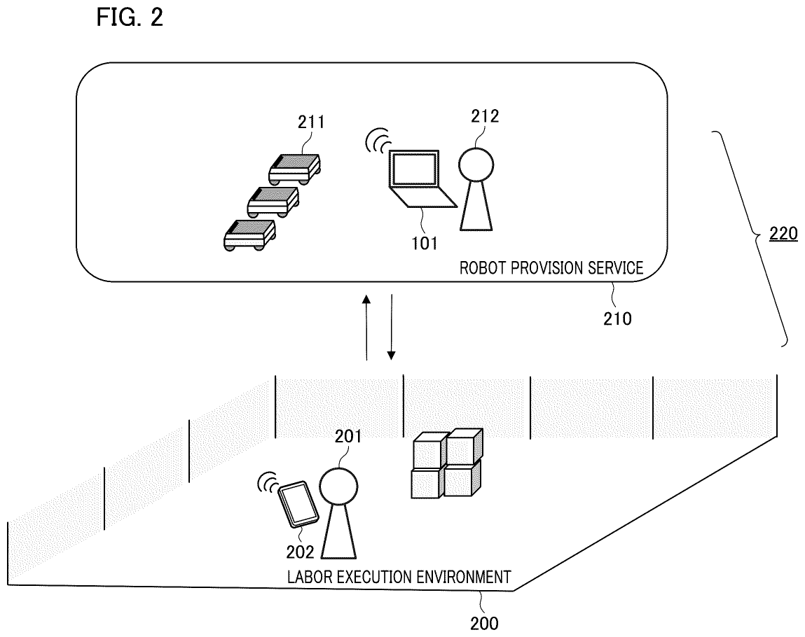

FIG. 2 is a diagram explaining an example of a usage scene of an information processing system 220 according to the first embodiment. The information processing system 220 according to the first embodiment has at least a user terminal 202 and the information processing apparatus 101.

An end user 201 requests a robot provision service 210 published on the network to provide the labor of cleaning the floor surface of a labor execution environment 200 through the user terminal 202. That is, the user terminal 202 may transmit a request for providing the labor in the designated environment.

The user terminal 202 has a camera mounted thereon and is a portable computer connected to a network, for example, a smartphone or tablet PC. The end user 201 further acquires sensor data (for example, a captured image) of the labor execution environment 200 by using the camera of the user terminal 202 and transmits the sensor data to the robot provision service 210.

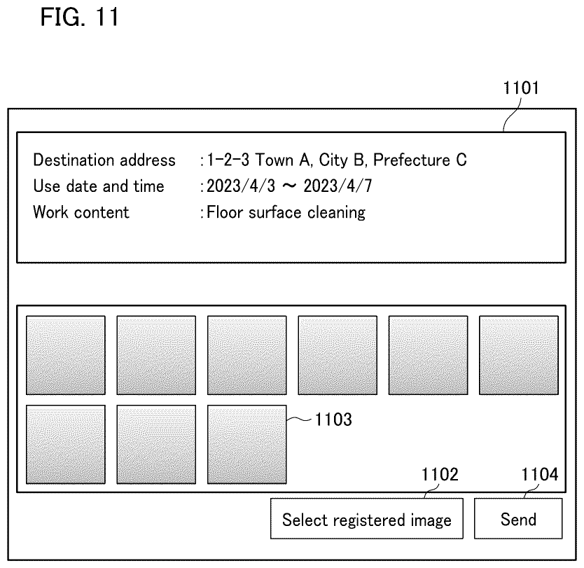

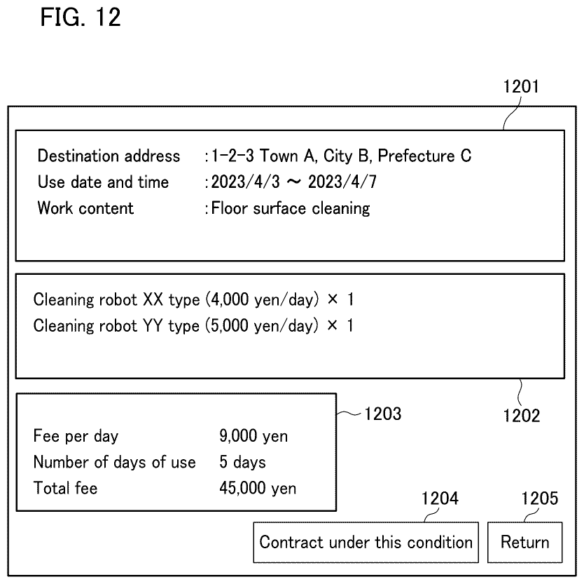

Examples of UI screens for the user to transmit sensor data and the like will be described below with reference to FIG. 11 and FIG. 12.

In the robot provision service 210, the information processing apparatus 101 receives the request for provision of the labor and the sensor data from the end user 201, and selects a robot suitable for provision of the labor from a plurality of task execution robots 211 managed by the robot provision service.

The robot provision service 210 proposes dispatch conditions such as the selected robot and the fee of the labor to the end user 201. When the end user 201 accepts the proposal, a contract is concluded with the robot provision service, and an operator 212 dispatches the robot to the labor execution environment 200.

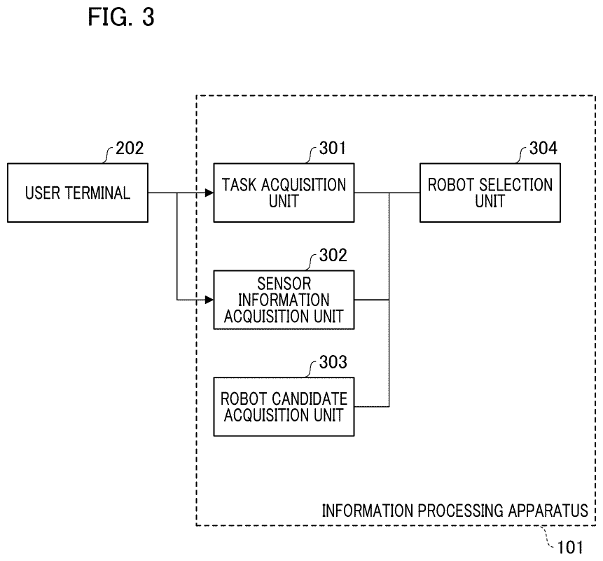

FIG. 3 is a functional block diagram illustrating an example of functional configuration of the information processing apparatus according to the first embodiment. Note that the processing of each unit to be described below is executed as software by reading a computer program from the ROM 112 and the like into the RAM 113 and then executing the program by the CPU 111.

However, some or all of each unit may be realized by hardware. As for the hardware, a dedicated circuit (ASIC), a processor (reconfigurable processor, DSP), and the like can be used.

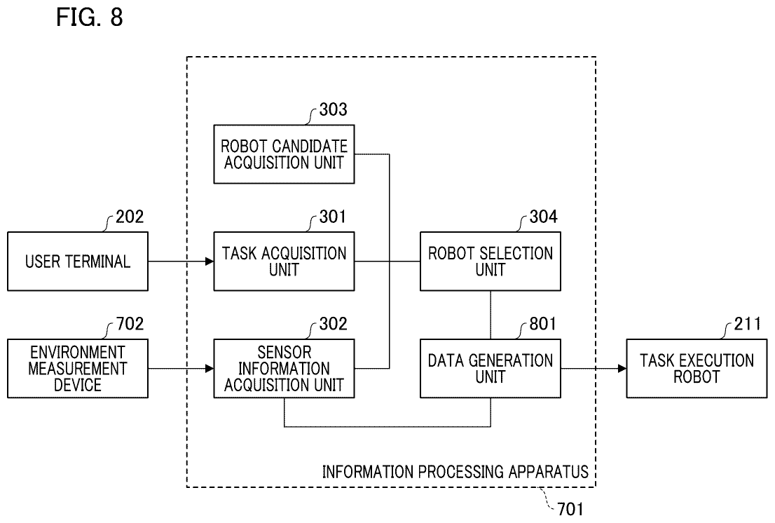

Additionally, each functional block as shown in FIG. 3 may not be incorporated in the same housing, and may be configured by separate devices connected to each other via a signal path. Note that the above explanation of FIG. 3 also applies to FIG. 8.

A task acquisition unit 301 acquires a request for providing the labor transmitted by the end user 201 via the user terminal. The sensor information acquisition unit 302 acquires sensor data that measured the labor execution environment 200.

A robot candidate acquisition unit 303 acquires a candidate list of robots that provide the labor. A robot selection unit 304 selects one or more robots that provide the labor from the candidate list of robots.

The candidate list of robots used in the first embodiment corresponds to the task execution robot 211 owned by the robot provision service and is stored in the storage unit 114.

The list includes a specification table and a use schedule table of the robot, and in the specification table, functions provided by each robot (a cleaning method of a floor surface and the like), a material condition of a floor surface that can be cleaned, a step and inclination condition of a floor surface on which the robot is operable, a provision cost (unit price), and the like are described.

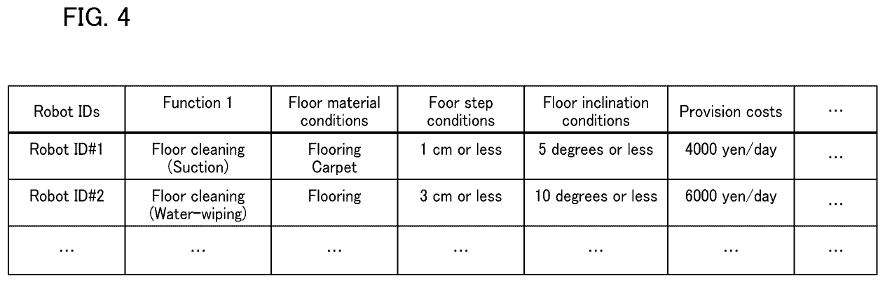

FIG. 4 illustrates an example of the content of the candidate list of robots according to the first embodiment and illustrates an example of a specification table of the robot. In the specification table of FIG. 4, a robot ID, a function 1 (suction, water-wiping, and the like in the case of cleaning), a floor surface material condition, a floor surface step difference condition, a floor surface inclination condition, a provision cost, and the like are tabulated.

Note that in the use schedule table (not illustrated), a time period during which new labor cannot be provided, such as a dispatch schedule and a maintenance schedule of each robot, is described.

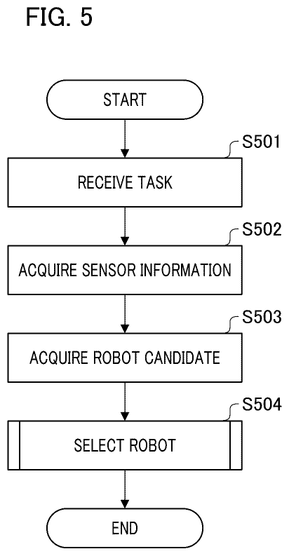

FIG. 5 is a flowchart illustrating an example of processes of an information processing method using the information processing apparatus according to the first embodiment. Note that the CPU 111 serving as a computer in the information processing apparatus executes a computer program stored in the memory, thereby sequentially performing the operation of each step in the flowchart of FIG. 5.

A series of processes as shown in FIG. 5 starts when the information processing apparatus 101 receives a request for providing the labor and an image group of the labor execution environment 200 that has been transmitted by the end user 201.

In step S501, the CPU 111 receives a task by the task acquisition unit 301. That is, the request for providing the labor transmitted in advance by the end user 201 is acquired. The request for providing the labor includes information on the content of the labor to be provided (in this case, cleaning of the floor surface), the sending destination address of the robot at the time of providing the labor, and the provision period.

Here, step S501 functions as a task acquisition step of acquiring a request for providing the labor in a designated environment by the task acquisition unit 301 serving as a task acquisition means.

In step S502, the CPU 111 acquires an image group of the labor execution environments 200 transmitted in advance by the end user 201, by the sensor information acquisition unit 302. Here, step S502 functions as a sensor information acquisition step of acquiring sensor information obtained by measuring the inside of the environment by one or more sensors by the sensor information acquisition unit 302 serving as a sensor information acquisition means.

In step S503, the CPU 111 causes the robot candidate acquisition unit 303 to acquire the candidate list of robots that provide the labor from the storage unit 114. Here, step S503 functions as a robot candidate acquisition step of acquiring information on a candidate group of robots that provide labor from the robot candidate acquisition unit 303 serving as a robot candidate acquisition means.

In step S504, the CPU 111 causes the robot selection unit 304 to select one or more robots that provide the labor from the candidate list of robots acquired in step S503.

Here, step S504 functions as a robot selection step of selecting a first robot group that includes one or more robots capable of providing the labor from the candidate group based on the request and the sensor information by the robot selection unit 304 serving as a robot selection means.

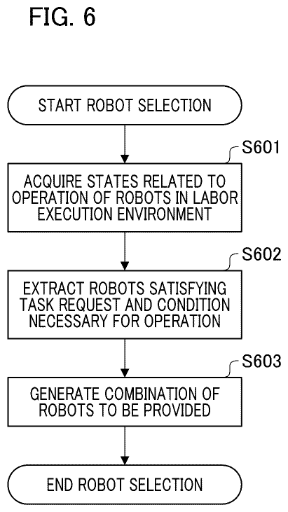

FIG. 6 is a flowchart illustrating details of a processing example of step S504. Note that the CPU 111 serving as a computer in the information processing apparatus executes a computer program stored in a memory to sequentially perform the operation of each step in the flowchart of FIG. 6.

In step S601, the CPU 111 causes the robot selection unit 304 to analyze the image group acquired in step S502, and acquires the state of the labor execution environments 200 related to the operation of the robot.

Specifically, the robot selection unit 304 estimates the material of the floor surface of the labor execution environment 200, the size of the step of the floor surface, and the angle of the inclination of the floor surface from the image by using a machine learning model learned in advance. In a case in which the labor execution environment 200 includes a plurality of regions and it is estimated that each region has a different material, step, and inclination, estimation is performed for each region.

Furthermore, in step S602, the CPU 111 causes the robot selection unit 304 to extract robots capable of providing the labor with the request content acquired in step S501, from the list acquired in step S503.

Specifically, first, the use schedule tables of the robots are referred to, and the robots capable of providing the new labor at the designated date and time and the sending destination address are extracted. Furthermore, from among the extracted robots, robots for which the floor surface material of the labor execution environment 200 estimated in step S601 matches the cleanable floor surface material conditions in the specification table are extracted.

Furthermore, from among the extracted robots, the step difference and inclination of the labor execution environment 200 are compared to the step difference and inclination conditions for floor surfaces on which each robot is operable in the specification table, and a robot is extracted for which the step difference and inclination of the labor execution environment 200 are equal to or less than the step difference and inclination conditions for floor surfaces on which the robot is operable.

In a case in which the labor execution environment 200 includes a plurality of regions and each region is estimated to have different material, step, and inclination, a robot capable of providing the labor is extracted for each region.

In step S603, the CPU 111 causes the robot selection unit 304 to select a combination of one or more robots suitable for providing the requested labor from among the robots extracted in step S602.

Specifically, one or more robots capable of providing the labor are selected for each region of the labor execution environment 200, and a combination is selected that minimizes the total number of robots required to provide the labor across all regions. That is, robots that can be selected in a plurality of regions are prioritized and selected. In a case in which a plurality of combinations satisfying the above conditions is present, any one combination among these combinations is selected.

That is, in the first embodiment, the robot selection unit 304 uses the efficiency of providing the labor of the robots of the candidate group as a criterion for selection.

As described above, the information processing apparatus, the information processing method, and the computer program described in the first embodiment are executed, so that it is possible to select a robot suitable for providing the labor in a site environment desired by a user. Therefore, it is possible to stably operate the selected robot as expected in the labor execution environment.

### Modification of First Embodiment

In the first embodiment, an example has been explained in which the end user 201 acquires an image of the labor execution environment 200 using the camera of the user terminal 202, and estimates the material, the step difference, and the inclination of the floor surface of the labor execution environment 200 from the image by using a machine learning model learned in advance.

However, the type of the sensor data to be acquired and the method of acquiring the state of the labor execution environment 200 are not limited thereto. In the present embodiment, any sensor data that enables acquisition of the state of the labor execution environment 200 and enables determination of whether or not the robot can operate can be used.

For example, the material, step difference, inclination, and the like of the floor surface may be estimated using a video image and measurement data of a distance sensor instead of an image. Additionally, the step difference and shape of the floor surface may be estimated by using a known three-dimensional reconstruction technology from a plurality of images, without using a machine learning model.

Alternatively, temperature ranges within which each robot is operable may be described in the specification table of the robot, and whether operation is possible may be determined based on the temperature of the labor execution environment 200 acquired by the temperature sensor.

Alternatively, in a case in which the robot requires a communication environment to provide the labor, the state of the communication environment measured by the user terminal 202 may be transmitted as sensor data and used as a determination factor for determining whether or not the robot can operate. By these methods, it is possible to select a robot based on various conditions measurable in the labor execution environment 200.

In the first embodiment, in step S603, a method has been explained of selecting a combination that minimizes the total number of robots required to provide the labor across all regions. However, the selection method is not limited thereto if the selected combination of robots is suitable for providing labor.

For example, a combination such that the total provision cost (amount of money) of the robots is minimized may be selected. Accordingly, it is possible to select a robot suitable for cost reduction on the end user 201 side. Thus, the robot selection unit 304 may use the amount of work or the cost of the labor as a selection criterion.

Although in the first embodiment, the labor for cleaning the floor surface and the cleaning robot have been explained as examples, the types of the labor and the robot that provides the labor are not limited thereto. The present embodiment is applicable to various labor that can be provided by a robot, such as security, transportation of a load, and gripping operation of a component by a robot arm.

In a case in which the present embodiment is applied to a mobile security robot and a transport robot, the robot can be selected based on conditions such as step differences and inclinations of floor surfaces on which each robot is operable

Alternatively, in a case in which the present embodiment is applied to a fixed security robot that monitors the surroundings with a camera and a robot that grips a component recognized by a camera with a robot arm, the illuminance of the environment estimated from the image may be used as a determination factor for determining whether or not the robot can operate. By these methods, it is possible to select a robot suitable for various labor other than floor surface cleaning.

Note that, in the first embodiment, a method of selecting a robot based on the sensor data acquired in step S502 has been explained. However, there may be a case in which information for selecting a robot is insufficient, for example, in a case in which there is no image of a floor surface and thus the state of the floor surface cannot be determined in step S601.

In such a case, the information processing apparatus 101 may interrupt the robot selection processing in step S601 and notify the end user 201 or the user terminal 202 that the information is insufficient.

That is, in a case in which the sensor information is insufficient as a selection criterion, the robot selection unit 304 may notify a device on which the sensor is mounted or a predetermined user that additional sensor information is necessary.

The notification transmitted by the information processing apparatus 101 can include request information such as the type of the sensor data that is lacking and the position and orientation in the labor execution environment 200 from which the sensor data is to be acquired. That is, the above notification may include information on the content of sensor information that needs to be added.

As a result, the end user 201 acquires additional sensor data and transmits the additional sensor data to the robot provision service 210, so that the robot selection processing can be performed again based on sufficient information.

Additionally, in the first embodiment, a method of selecting a combination of one or more robots suitable for providing the requested labor in the process of step S602 has been explained. However, depending on the state of the labor execution environment 200, there may be a case in which a suitable combination of robots cannot be selected, in a case in which there is no robot that can provide labor for a certain region in the environment.

In such a case, the information processing apparatus 101 may notify the end user 201 or the user terminal 202 that a robot capable of providing the labor for the region cannot be prepared, and select a combination of robots based on the remaining regions. Thereby, the end user 201 can receive provision of a part of the requested labor.

Additionally, the reason why it is determined that each robot cannot provide the labor in the corresponding region (the labor execution environment condition, the cost, and the like) may be included in the content of the notification. In this case, the end user 201 may improve the state of the labor execution environment 200 based on the notification and transmit the sensor data obtained by measuring the labor execution environment 200 again.

Alternatively, a condition related to the cost may be changed. As a result, it becomes possible for the end user 201 to receive the requested labor provision under the improved labor execution environment 200 or cost conditions.

Thus, the robot selection unit 304 may, in a case in which there is no combination of robots selectable as the first robot group in the candidate group, provide a notification to the predetermined user on conditions necessary for any combination of robots in the candidate group to be able to provide the labor.

Thus, according to the first embodiment and the modification thereof, it is possible to realize an information processing apparatus capable of stably executing labor by a robot in a designated environment.

### Second Embodiment

In the first embodiment, a method of selecting a robot based on a measurement result of a sensor mounted on a user terminal has been explained.

In the second embodiment, an environment measuring device that is different from the user terminal is used, a robot suitable for providing the labor is selected from the measurement results, and data used by the selected robot when the labor is provided is generated.

Note that the physical configuration of an information processing apparatus 701 according to the second embodiment is similar to that of the information processing apparatus 101 explained in the first embodiment, and the description thereof will be omitted.

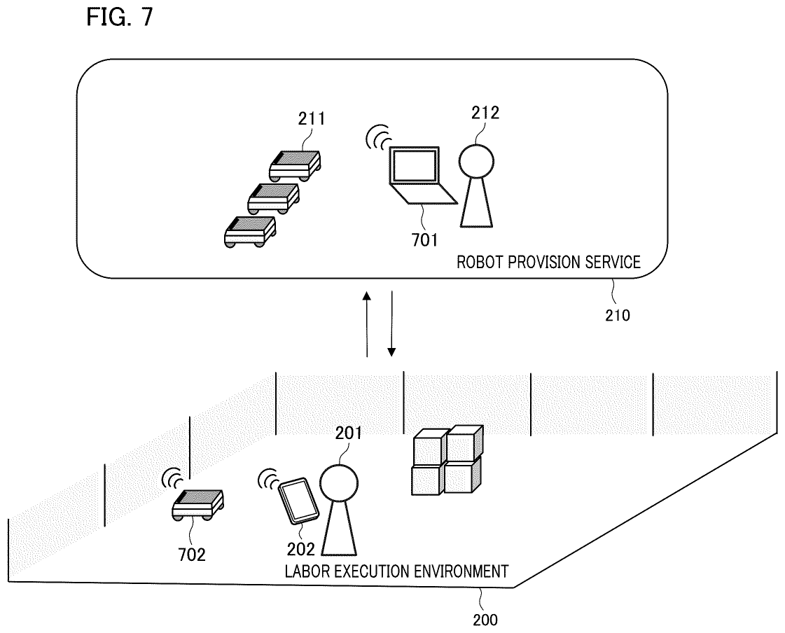

FIG. 7 is a diagram explaining a usage scene of the information processing apparatus according to the second embodiment. An end user 201 requests a robot provision service 210 published on the network to provide the labor of cleaning the floor surface of a labor execution environment 200 through the user terminal 202.

The robot provision service 210 transmits the environment measurement device 702 to the labor execution environment 200 in order to obtain more detailed information of the labor execution environment 200. When the user activates the environment measurement device 702, the environment measurement device 702 acquires sensor data of the labor execution environment 200 by using the mounted sensor while autonomously moving in the labor execution environment 200 and transmits the sensor data to the robot provision service.

In the robot provision service 210, the information processing apparatus 701 receives the request for provision of the labor transmitted from the end user 201 and the sensor data transmitted from the environment measurement device 702, and selects a robot suitable for provision of the labor from the task execution robots 211 owned by the robot provision service.

The robot provision service 210 proposes dispatch conditions such as the selected robot and the fee of the labor to the end user 201. When the end user 201 accepts the proposal, a contract is concluded with the robot provision service, and the operator 212 dispatches the robot suitable for providing the labor to the labor execution environment 200.

The environment measurement device 702 in the second embodiment is a movable apparatus on which a 2D light detection and ranging (LiDAR) and a stereo camera are mounted as sensors. Additionally, the environment measurement device 702 can generate map data in the environment by, for example, a known simultaneous localization and mapping (SLAM) technology based on the sensor data and autonomously move in the environment.

Additionally, the environmental measurement device 702 is connected to a network, and can automatically transmit measured sensor data to the robot provision service 210. In the map data generated, information on feature points in the environment observed by each of the 2D-LiDAR and the stereo camera is described.

Hereinafter, a configuration of an information processing apparatus according to the second embodiment will be explained. FIG. 8 is a functional block diagram illustrating a functional configuration example of the information processing apparatus according to the second embodiment.

The processing of each unit in FIG. 8 is performed as software by reading a computer program from the ROM 112 and the like into the RAM 113 and then executing the program by the CPU 111.

The basic functions of the task acquisition unit 301, the sensor information acquisition unit 302, the robot candidate acquisition unit 303, and the robot selection unit 304 are similar to those in the first embodiment, and the description thereof will be omitted.

A data generation unit 801 functions as a data generation unit, and generates data to be used by the task execution robot 211 in the labor execution environment 200 based on the sensor data obtained by measuring the labor execution environment 200. That is, the data generation unit 801 generates, based on the sensor information, work data to be used by any robot of the first robot group to provide labor in the environment.

Similarly to the first embodiment, the candidate list of robots used in the second embodiment includes a specification table and a usage schedule table of the robot. In the specification table of a robot used in the second embodiment, the type of the sensor to be used by each robot for self-position measurement during cleaning is described, in addition to the contents explained in the first embodiment.

The type of the sensor is, for example, a 2D-LiDAR, a stereo camera, or both the 2D-LiDAR and the stereo camera. That is, it is assumed that any robot of the first robot group has mounted thereon a sensor corresponding to at least one of the one or more sensors included in the environment measurement device 702.

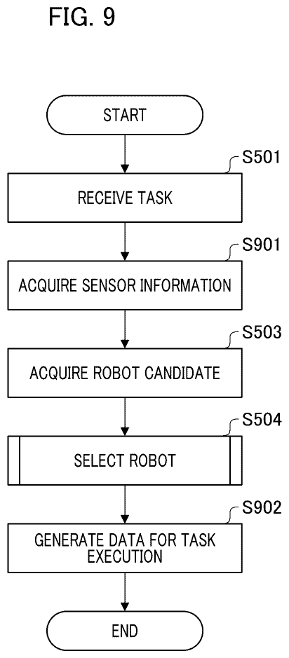

Next, FIG. 9 is a flowchart illustrating a processing example of an information processing method according to the second embodiment. Note that when the CPU 111 serving as a computer in the information processing apparatus executes a computer program stored in the memory, the operation of each step in the flowchart of FIG. 9 is sequentially performed.

A series of processes in FIG. 9 starts when the information processing apparatus 101 receives a request for providing the labor transmitted by the end user 201 and sensor data of the labor execution environment 200 measured by the environment measurement device 702.

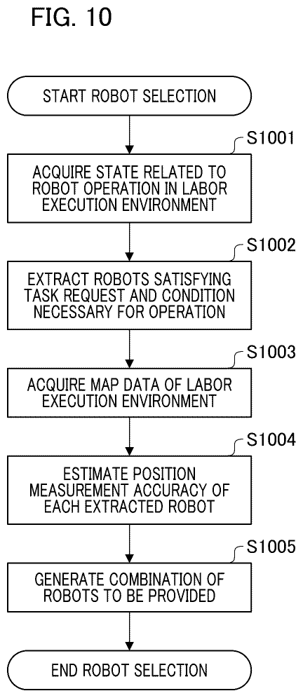

Since the overview of the processes of steps S501 and S503 and the process of step S504 are similar to those in the first embodiment, and the explanation thereof will be omitted. Details of the process of step S504 will be described below by using FIG. 10.

In step S901, the CPU 111 causes the sensor information acquisition unit 302 to acquire sensor data of the labor execution environments 200 measured by the environmental measurement device 702. In this context, the sensor data are measurement data of the 2D-LiDAR and the stereo camera, and map data of the labor execution environment 200 generated by the environment measurement device 702 during measurement.

In step S902, the CPU 111, by using the data generation unit 801, generates map data to be used by the task execution robot 211 in the labor execution environment 200 and transmits the generated map data to the task execution robot 211. The transmitted map data is used by the task execution robot 211 for position measurement in the environment.

Thus, the work data generated by the data generation unit 801 includes map data for any robot of the first robot group to measure a position and/or an orientation of the robot itself in the environment.

Specifically, data corresponding to the sensor for self-position measurement mounted on the selected task execution robot 211 is extracted from the map data of the labor execution environment 200 acquired in step S901, and is saved as new map data. In a case in which there are a plurality of selected robots, map data is generated and transmitted for each robot having a sensor corresponding to the acquired map data.

The map data acquired in step S901 is generated by using the 2D-LiDAR and the stereo camera, and includes feature data in the environment measured by both the sensors.

For example, in a case in which the selected task execution robot 211 is a robot having only a stereo camera mounted thereon, the new map data is generated by extracting, from the acquired map data, only those features measured by the stereo camera.

Because the original map data is generated by using both the 2D-LiDAR and the stereo camera, the new map data has a higher accuracy than map data generated using only the stereo camera.

FIG. 10 is a flowchart illustrating a detailed example of the process of step S504 according to the second embodiment. Note that the CPU 111 serving as a computer in the information processing apparatus executes a computer program stored in a memory to sequentially perform the operation of each step in the flowchart of FIG. 10.

In step S1001, the CPU 111 causes the robot selection unit 304 to analyze the measurement data of the stereo camera acquired in step S901, and acquires a state related to the operation of the robot in the labor execution environment.

Specifically, the robot selection unit 304 uses a machine learning model learned in advance to estimate the material, step difference, and inclination of the floor surface of the labor execution environment 200 from the image of the stereo camera. In a case in which the labor execution environment 200 includes a plurality of regions and it is estimated that each region has a different material, step, and inclination, estimation is performed for each region.

In step S1002, the CPU 111 causes the robot selection unit 304 to extract a robot that can provide the labor according to the request content acquired in step S501, from the list acquired in step S503.

Specifically, first, the use schedule tables of the robots are referred to, and the robots capable of providing the new labor at the designated date and time and the sending destination address are extracted. Furthermore, the robots in which the materials of the floor surfaces of the labor execution environment 200 estimated in step S1001 match the conditions of the materials of the floor surfaces that can be cleaned in the specification table are extracted from among the extracted robots.

Furthermore, from among the extracted robots, the step difference and inclination of the labor execution environment 200 are compared to the step difference and inclination conditions for floor surfaces on which each robot is operable in the specification table, and a robot is extracted for which the step difference and inclination of the labor execution environment 200 are equal to or less than the step difference and inclination conditions for floor surfaces on which the robot is operable.

In a case in which the labor execution environment 200 includes a plurality of regions and it is estimated that each region has a different material, step, and inclination, a robot capable of providing the labor is extracted for each region.

In step S1003, the CPU 111 causes the robot selection unit 304 to obtain the map data of the labor execution environment 200. In this context, the map data obtained by the sensor information acquisition unit 302 in step S901 is directly used.

In step S1004, the CPU 111 causes the robot selection unit 304 to estimate the self-position measurement accuracy in the labor execution environment 200 for each robot extracted in step S1002, based on the map data acquired in step S1003. In a case in which the labor execution environment 200 includes a plurality of regions, the position measurement accuracy in each region is estimated for each robot.

Specifically, for the corresponding region on the map data, the amount of feature points that can be used by the sensor for self-position measurement mounted on the target robot is acquired. If the amount of usable feature points exceeds a predetermined threshold, the CPU 111 determins that the robot has self-position measurement accuracy that enables labor provision in the corresponding region.

In step S1005, the CPU 111 causes the robot selection unit 304 to select a combination of one or more robots suitable for providing the requested labor from among the robots determined to have the self-position measurement accuracy with which labor can be provided in step S1004.

Specifically, one or more robots capable of providing the labor are selected for each region of the labor execution environment 200, and a combination is selected that minimizes the total number of robots required to provide the labor across all regions. That is, robots that can be selected in a plurality of regions are prioritized and selected. In a case in which a plurality of combinations satisfying the above conditions is present, any one combination among these combinations is selected.

Thus, in the second embodiment, the robot selection unit 304 uses the measurement accuracy of the self-position and/or orientation of the robot of the candidate group in the environment as the selection criterion.

As described above, by executing the information processing apparatus, the information processing method, and the computer program according to the Second Embodiment, a robot suitable for providing the labor can be selected while taking into consideration the self-position measurement accuracy of the robot in a site environment desired by the user.

Additionally, the data used by the selected robot in the labor execution environment can be generated from the sensor data measured in advance. Therefore, the selected robot can be stably operated as expected in the labor execution environment.

### Modification of Second Embodiment

In the second embodiment, an example in which, in step S901, measurement data of the 2D-LiDAR and the stereo camera and map data are acquired as sensor data has been explained. However, the types of sensor data to be acquired are not limited thereto.

Similarly to the first embodiment, in the present embodiment, any sensor data that can determine whether or not the robot can operate can be used. For example, a 3D-LiDAR may be used. Alternatively, in a case in which the environment measurement device 702 has mounted thereon a camera that captures an image of the floor surface as explained in the first embodiment, the captured image may be acquired.

Alternatively, a measurement value of a temperature sensor and a state of a communication environment may be acquired. The information processing apparatus 701 can perform robot selection and perform generation of task execution data by using the various types of sensor data.

Additionally, in the second embodiment, the method of measuring the labor execution environment 200 by using the environment measurement device 702, which is a movable apparatus having a sensor mounted thereon and capable of autonomous movement, has been explained. However, the form of the sensor device is not limited thereto and may be another form if the shape of the environment can be measured.

For example, the sensor device may be a movable apparatus that the user moves by hand, a device that can be carried by hand, or a sensor device that travels by remote control. Alternatively, in a case in which the user terminal 202 and the task execution robot 211 have mounted thereon a sensor capable of measuring the shape of the environment, the sensor may be used. That is, the measurement information of the environment measurement device 702 and the sensor information of the user terminal 202 may be used in combination.

In the second embodiment, an example in which, in step S1003, the map data acquired by the sensor information acquisition unit 302 in step S901 is used has been explained. However, the method of acquiring the map data to be used for robot selection is not limited thereto.

For example, sensor data and the like may be acquired from an external server in step S901, and map data may be generated in the information processing apparatus 701 from this sensor data by using a known SLAM technology and the like. Thus, a robot can be appropriately selected even in a case in which the sensor device does not have a map creation function.

Additionally, in the second embodiment, the accuracy of self-position measurement of each robot is estimated based on the map data acquired in step S1003, and the accuracy is used as a criterion for determining the selection of a robot. However, the criterion for robot selection when the map data is used is not limited thereto.

For example, from the positions of feature points in the map data, the location of obstacles in the labor execution environment 200 and the spatial extent of the movement path (for example, the width or height of a passage) may be estimated, and based on these estimated spatial parameters, whether each robot can move or pass through each region may be determined.

Specifically, characteristics such as the size of each robot and the turning performance during movement are described in the specification table of the robot, and it is possible to determine whether or not the robot can move in the corresponding region by comparing these characteristics and the location of obstacles in the environment and the spatial extent of the movement path. Thus, a risk can be avoided wherein the selected robot does not operate as expected due to physical obstacles in the labor execution environment.

Note that, in the second embodiment, a method has been explained in which, in step S1004, position measurement accuracy is determined based on the amount of feature points usable by the self-position measurement sensor. However, the method for determining position measurement accuracy is not limited thereto.

For example, the position measurement accuracy may be estimated by statistically processing spatial uneven distribution and distance distribution of feature points that can be observed from a certain point, individual characteristics of characteristic points, and the like.

Additionally, in the second embodiment, in step S1005, the method of selecting a combination that can provide labor for each region of the labor execution environment 200 and that minimizes the number of robots selected as a whole has been explained. However, the method for selecting a combination of robots is not limited thereto.

For example, there is a case in which the request for provision of labor received in step S501 includes time constraints such as completing execution (cleaning) of one task within a predetermined time (for example, within 30 minutes). In such a case, it is possible to select a combination of robots that can satisfy the requested time constraints based on the execution efficiency of the task of robot and the size of the labor execution environment 200.

That is, the request from the user may include information on a time limit of provision of labor, and the robot selection unit 304 may select the first robot group capable of executing the labor within the time limit based on the amount of work.

Specifically, the throughput (area that can be cleaned per unit time) of each robot is described in the specification table of the robot, and the work time for the combination of robots can be estimated by estimating the size of each region from the map data.

In such a case, it is also possible to satisfy the requested time constraints by shortening the work time by assigning a plurality of robots to each region. Additionally, the size of the labor execution environment 200 may be estimated directly from the sensor data, instead of estimating the size of the labor execution environment 200 from the map data. By these methods, it is possible to select a robot that takes into consideration the time required to perform labor.

Additionally, the throughput of each robot may change depending on the state of the labor execution environment 200. In such a case, a table describing throughput values for each condition may be prepared in the specification table, and a combination of robots may be selected according to the throughput determined from the sensor data.

For example, in a case in which the accuracy of the self-position measurement of the robot is not sufficient in a certain region, although it is possible to provide the labor, there is a case in which work at a lower speed is required. In such a case, the self-position measurement accuracy can be determined in stages based on a plurality of predetermined thresholds from the amount of feature points that can be used in step S1004, and the throughput corresponding to each stage can be acquired from the specification table.

Additionally, in the second embodiment, in step S902, the method in which the task execution robot 211 generates map data to be used in the labor execution environment 200 has been explained. However, the data generated by the data generation unit 801 is not limited thereto. The data generated by the data generation unit 801 may be data for improving the operation performance of the task execution robot 211 in the labor execution environment 200.

For example, optimal exposure setting parameters of the stereo camera may be calculated based on the sensor data and transmitted to the task execution robot 211. Accordingly, it is possible to improve the operation stability of the task execution robot 211 in the labor execution environment 200. That is, the work data generated by the data generation unit 801 may include the parameters of the sensors mounted on the first robot group.

In the second embodiment, the method of performing robot selection processing by the environment measurement device 702, which is a movable apparatus having a sensor mounted thereon, and the independent information processing apparatus 701 has been explained. However, the embodiment of the information processing apparatus is not limited thereto.

For example, a sensor may be mounted on the information processing apparatus 701 to measure the inside of the labor execution environment 200. Alternatively, an information processing apparatus installed in the environment measurement apparatus 702 may perform a series of processes.

In the second embodiment, the method of selecting a robot based on the sensor data acquired in step S901 has been explained. However, there may be cases in which information for selecting a robot is insufficient, such as a case in which the acquired map data does not cover the labor execution environment 200 and the self-position measurement accuracy of the robot in the entire environment cannot be estimated.

In such a case, the information processing apparatus 101 may interrupt the robot selection processing in step S1004 and notify the end user 201, the user terminal 202, or the environmental measurement device 702 that the information is insufficient.

The notification transmitted by the information processing apparatus 101 can include request information such as the type of the sensor data that is lacking and the position and orientation in the labor execution environment 200 from which the sensor data is to be acquired.

Accordingly, by having the environment measurement device 702 acquire additional sensor data and transmit it to the robot provision service 210, the robot selection processing can be performed again based on sufficient information.

Additionally, in the second embodiment, self-position measurement accuracy is estimated from measurement results obtained by a sensor device capable of measuring the shape of the environment, a robot suitable for providing the labor is selected based on this estimated accuracy, and generates data to be used when the selected robot provides labor.

It is not necessary to perform selection of a robot and generation of the data at the same time, and only one of the methods may be performed. For example, in the second embodiment, the process of step S902 may be omitted, and the map data may be separately created after the selected robot arrives at the labor execution environment 200.

Additionally, as in the first embodiment, the state of the floor surface may be estimated and robots may be selected based on the user terminal, and at the same time, optimal exposure settings for the stereo camera may be calculated by estimating the brightness of the labor execution environment 200 from the captured images of the user terminal.

FIG. 11 is a diagram illustrating an example of a UI screen for the user of the information processing apparatus according to the first embodiment or the second embodiment to transmit sensor data and illustrates an example of a UI screen for the end user 201 to transmit sensor data of the labor execution environment 200 to the robot provision service.

The content of the request for providing the labor registered by the end user 201 is displayed in a region 1101 in the upper part of the screen. The end user 201 presses a button 1102 and selects an image group in the terminal through an image selection screen that is separately displayed.

The selected image group is displayed as a thumbnail group 1103. When the end user 201 presses down a button 1104, this selected image group is transmitted to the robot provision service.

FIG. 12 illustrates an example of a UI screen for the user of the information processing apparatus according to the first embodiment or the second embodiment to confirm the selected robot, which shows an example UI screen for the end user 201 to confirm the proposal from the robot provision service 210. In a region 1201 in the upper part of the screen, the content of the request for provision of labor registered by the end user 201 is displayed.

In a region 1202 of the screen interruption, the information on the robot to which the labor is to be provided, which is proposed by the robot providing service, is displayed. Specifically, the information related to the first robot group selected by the robot selection unit 304 serving as a robot selection means is displayed on the display unit serving as the display unit by the display control unit 116. Additionally, in a region 1203 on the lower left of the screen, a total fee and information related thereto are displayed.

When the end user 201 presses down a button 1204, a contract for dispatching the robot displayed in the screen 1202 is concluded in response to the request displayed in the screen 1201. A button 1205 is a return button for the end user 201 to leave the contract confirmation screen without concluding the contract.

Note that although an example of a cleaning robot has been explained in the above embodiments, the movable apparatus need not be a robot but may be an autonomous movable apparatus such as an AGV (Automated Guided Vehicle) or AMR (Autonomous Mobile Robot). Additionally, the movable apparatus may be, for example, a vehicle for transporting people or packages, or a drone.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-000294, filed on Jan. 4, 2024, which is hereby incorporated by reference herein in its entirety.

What is claimed is:

1. An information processing apparatus comprising:
one or more memories storing instructions; and
one or more processors executing the instructions to:
acquire a request for provision of labor in a specified environment;
acquire sensor information measured by one or more sensors inside the environment;
acquire information on a candidate group of robots that provide the labor; and
select a first robot group that includes one or more robots capable of providing the labor from the candidate group based on the request and the sensor information.

2. The information processing apparatus according to claim 1, wherein the one or more processors are further configured to execute the instructions to display information related to the selected first robot group on a display unit.

3. The information processing apparatus according to claim 1, wherein when selecting the first robot group, a provision efficiency of the labor of a robot of the candidate group is used as a criterion for the selection.

4. The information processing apparatus according to claim 1, wherein when selecting the first robot group, measurement accuracy of self-position and/or orientation of a robot of the candidate group in the environment is used as a criterion for the selection.

5. The information processing apparatus according to claim 1, wherein when selecting the first robot group, an amount of work or a cost of the labor is used as a criterion for the selection.

6. The information processing apparatus according to claim 1, wherein the request includes information on a time limit of provision of the labor, and when selecting the first robot group, the first robot group capable of executing the labor within the time limit is selected based on an amount of work.

7. The information processing apparatus according to claim 1, wherein the one or more processors are further configured to execute the instructions to generate work data to be used by any robot of the first robot group for providing the labor in the environment based on the sensor information.

8. The information processing apparatus according to claim 7, wherein the work data includes map data for any robot of the first robot group to measure self-position and/or orientation in the environment.

9. The information processing apparatus according to claim 7, wherein the work data includes parameters of sensors mounted on robots of the first robot group.

10. The information processing apparatus according to claim 1, wherein any robot of the first robot group has mounted thereon a sensor corresponding to at least one of the one or more sensors.

11. The information processing apparatus according to claim 1, wherein when selecting the first robot group, in a case in which the sensor information is insufficient as a criterion for selection, an apparatus having the sensor mounted thereon or a predetermined user is notified of the necessity of additional sensor information.

12. The information processing apparatus according to claim 11, wherein the notification includes information related to a content of the sensor information that needs to be added.

13. The information processing apparatus according to claim 1, wherein when selecting the first robot group, in a case in which no combination of robots selectable as the first robot group exists in the candidate group, a condition necessary for any combination of robots in the candidate group to become capable of providing the labor is notified to a predetermined user.

14. An information processing system comprising:
one or more memories storing instructions; and
one or more processors executing the instructions to:
transmit a request for provision of labor in a specified environment by means of a user terminal;
acquire the request transmitted by the user terminal;
acquire sensor information measured by one or more sensors inside the environment;
acquire information on a candidate group of robots that provide the labor; and
select a first robot group that includes one or more robots capable of providing the labor from the candidate group based on the request and the sensor information.

15. An information processing method comprising:
acquiring a request for provision of labor in a specified environment;
acquiring sensor information measured by one or more sensors inside the environment;
acquiring information on a candidate group of robots that provide the labor; and
selecting a first robot group that includes one or more robots capable of providing the labor from the candidate group based on the request and the sensor information.

16. A non-transitory computer-readable storage medium storing a computer program including instructions for executing following processes:
acquiring a request for provision of labor in a specified environment;
acquiring sensor information measured by one or more sensors inside the environment;
acquiring information on a candidate group of robots that provide the labor; and
selecting a first robot group that includes one or more robots capable of providing the labor from the candidate group based on the request and the sensor information.
